(19) United States
(12) Patent Application Publication
(10) Pub. No.: US 2018/0290925 A1
(43) Pub. Date: Oct. 11, 2018

(54) USE OF A GEOPOLYMER WITH SUPERABSORBENT POLYMER

(71) Applicant: COMMISSARIAT À L'ÉNERGIE ATOMIQUE ET AUX ÉNERGIES ALTERNATIVES, Paris (FR)

(72) Inventors: Arnaud Poulesquen, Les Angles (FR); Adrien Gerenton, Avignon (FR); Fabien Frizon, Villeneuve Les Avignon (FR); Thomas Piallat, Orange (FR)

(21) Appl. No.: 15/762,437

(22) PCT Filed: Sep. 23, 2016
(86) PCT No.: PCT/EP2016/072630

§ 371 Date: Mar. 22, 2018

(30) Foreign Application Priority Data
Sep. 25, 2015 (FR) 15 59078

(51) Int. Cl. C04B 28/00; C04B 28/26

(52) U.S. Cl. CPC C04B 28/006; C04B 2111/00155; C04B 28/26

(57) ABSTRACT

The present invention relates to a composite material including at least one superabsorbent polymer in a geopolymer matrix as a material for 3D printing.

### TECHNICAL FIELD

The present invention relates to the technical field of geopolymers and, in particular, the technical field of geopolymers used in 3D printing.

More specifically, the present invention proposes a material including at least one superabsorbent polymer coated in a geopolymer matrix and this, for improving the properties, in particular, in terms of flow threshold, elasticity module and adhesion properties and thus improving the capacity of such a geopolymer material to be used in 3D printing.

The present invention also relates to method for preparing such a material and the different uses thereof, in particular for preparing a microporous and mesoporous geopolymer.

### PRIOR ART

Geopolymers are aluminosilicate materials synthesised from the alkaline activation of an alumino-silicate source, like for example, metakaolin and fly ash [1]. These are the mainly amorphous materials which typically have an intrinsic porosity of around 40-50% by volume in relation to the total material volume, an average pore size of between 4 and 15 nm and a specific surface of between 40 and 200 m²/g according to the alkaline activator used (sodium or potassium) [2].

Geopolymers are presented as having good mechanical resistances, good resistance to fire and acid attacks and can be used in various parts of the industry, like construction for heat insulation, nuclear for waste processing [3] or chemistry for the sequestration of toxic elements or other heavy metals [4].

Recently, the properties of geopolymers have also made them ideal materials for 3D printing. Indeed, in this field, creating objects or structures from geopolymer is a largely superior alternative to plastics, since it is a material that contains no carbon, which is comparable to stone, fireproof and difficult to break, and therefore has a superior durability.

However, when implemented in 3D printing, geopolymers can have certain disadvantages. For example, certain geopolymers, in particular those of which the alumino-silicate source is metakaolin, flow under their own weight since they have no flow threshold. In addition, their elastic module connected to local interactions between particles is particularly weak. These two characteristics are damaging in 3D printing, in particular during injecting geopolymer paste through 3D printing nozzles and in maintaining the hold of the printed shape.

Finally, 3D printing can require strengthened adhesion properties between the printed shape and the support surface whereon the 3D printing takes place, this surface could be hydrophobic.

The inventors have therefore set the aim of perfecting a geopolymer that is capable of responding to all or part of the limitations connected to 3D printing.

At the same time, superabsorbent polymers (or SAP) are materials which can absorb a large quantity of water or aqueous solutions. One gram of these polymers can absorb and retain up to 1000-1500 g of water. Superabsorbent polymers were developed at the end of the 1980s, being applied in pull-up nappies. SAPs are reticulated polyelectrolytes and the most common in the industry are sodium polyacrylates. When SAPs are immersed in an aqueous solution, they swell through osmotic pressure, of which the intensity is proportional to the quantity of ions present in the aqueous solution. The level of swelling also depends on the type of ions, since divalent ions (Ca²⁺) or trivalent ions (Al³⁺) act as additional cross-linking agents, thus reducing the absorption and swelling capacity [5].

SAP use in the cement industry is only very recent, since it started at the start of the 2000s. Hardened hydraulic cements are the result of hydrating finely ground materials from the cement mixture. The main aim of adding SAP in the cement mixture resides in their capacities to provide water, these polymers thus acting like a water tank, to control, over time, the hydration of cement particles and avoid auto-dessication and therefore fracturing.

Improving the durability of concrete is also a challenge of adding SAPs. Indeed, since the properties of hydric transport, which is what starts the early deterioration of concrete, are facilitated by the presence of interconnected capillary pores, the act of adding SAPs enables this capillary water to be redistributed into macropores filled with water, which is also beneficial for the resistance of concrete to the freezing/thawing cycle [6, 7].

### DESCRIPTION OF THE INVENTION

The present invention enables to remedy, at least in part, the disadvantages and technical problems connected to using a geopolymer in 3D printing. Indeed, the latter proposes a composite material wherein one or several superabsorbent polymer(s) is/are dispersed, coated and/or incorporated in a geopolymer matrix.

The work of the inventors has enabled to show that geopolymers and superabsorbent polymers have good compatibility. This work has also shown that adding at least one superabsorbent polymer in a geopolymer enables:

i) to increase elasticity, the flow threshold and the shear-thinning character of the composite material obtained, and this, to give an injectable material and, in particular, to be able to inject through 3D printer nozzles and such that the shape requested does not collapse;

ii) to modify and control the wettability properties of the mixture according to the application aimed for the composite material thus obtained, like underwater injection, leaching-proof barrier, soil stabilisation, etc.

iii) to modulate and, in particular, decrease the setting time of the composite material thus obtained; and

iv) to improve the adhesion properties of the composite material thus obtained.

Given the properties described above, the material according to the invention is particularly useful in the field of 3D printing, since it offers the possibility of developing geopolymer-based customised products which intrinsically have good mechanical properties, high specific surfaces, as well as a monomodal and mesoscopic size distribution of pores. Such products have the property of being injectable.

However, apart from the properties defined and other than the 3D printing aspect, it is also possible to consider using the material according to the invention, as a sealer, in the fresh air or immersed, as a seal or as sprayed concrete, given the drastic increase in rheological properties, like the increase in elasticity, the flow threshold and the shear-thinning character, as well as the adhesion properties.

It must be highlighted that adding SAPs in geopolymers had never been studied before the present invention, and that using such polymers in the hydraulic cement field, in particular as a water tank as explained above, left nothing to foretell the advantages and the properties obtained during using superabsorbent polymers in geopolymers.

Thus, the present invention proposes a composite material including at least one superabsorbent polymer in a geopolymer matrix.

By “composite material”, this means, in the framework of the present invention, a blend of a geopolymer matrix and one or several superabsorbent polymer(s). This blend can be presented in the form of an encapsulation of SAP by the geopolymer matrix, a micro-encapsulation of SAP by the geopolymer matrix and/or a coating of SAP by the geopolymer matrix.

More specifically, the composite material that is the subject of the invention is presented in the form of a geopolymer (or geopolymer matrix) wherein the SAP nodules and, in particular the SAP micronodules and/or nanonodules are coated. By “micronodule”, this means a mass of SAP of which the characteristic size is between 1 and 1000 μm, in particular, between 5 and 900 μm and, in particular, between 20 and 800 μm. By “nanomodule”, this means a mass of SAP of which the characteristic size is between 1 and 1000 nm, in particular, between 10 and 900 nm and, in particular, between 20 and 800 nm. SAP micronodules and nanonodules present in the composite material according to the invention can have varied shapes, such as oval, spheroid or polyhedral shapes. It is these nanonodules and micronodules which play a part, mainly, in the macroporous character of the final geopolymer obtained after removing the SAPs actually giving pores of varied shapes such as oval, spheroid or polyhedral shapes.

By “superabsorbent polymer” or SAP, this generally means a polymer, capable, in a dry state, of spontaneously absorbing at least 10 times, advantageously at least 20 times, the aqueous liquid weight thereof, in particular, water and particularly distilled water. Certain SAPs can absorb up to and even more than 1000 times or even more than 1500 times their liquid weight. By spontaneous absorption, this means an absorption time of less than or equal to 1 hour 30 minutes, and in particular, less than or equal to 1 hour.

The superabsorbent polymer implemented in the present invention can have a water-absorption capacity going from 10 to 2000 times its own weight (that is 10 g to 2000 g of absorbed water per gram of absorbent polymer), advantageously from 20 to 2000 times its own weight (that is 20 g to 2000 g of absorbed water per gram of absorbent polymer), in particular, from 30 to 1500 times its own weight (that is 30 g to 1500 g of absorbed water per gram of absorbent polymer) and, more specifically, from 50 to 1000 times its own weight (that is 50 g to 1000 g of absorbed water per gram of absorbent polymer). These water-absorption characteristics are understood to be under normal temperature (25° C.) and pressure (760 mm Hg, that is 100000 Pa) conditions and for distilled water.

The SAP of the composite material according to the invention can be chosen among poly(meth)acrylates of alkaline salts, starches grafted by a (meth)acrylic polymer, hydrolysed starches grafted by a (meth)acrylic polymer; polymers based on starch, resin and cellulose derivative; and their mixtures.

More specifically, the SAP that can be used in the composite material according to the invention can be, for example, chosen among:
polymers resulting from polymerisation with partial cross-linking of water-soluble ethylenic unsaturated monomers, such as acrylic, methacrylic (in particular from polymerisation of acrylic and/or methacrylic acid and/or acrylate and/or methacrylate monomers) or vinylic monomers, in particular, cross-linked and neutralised poly(meth)acrylates, in particular in gel-form; and salts, in particular, alkaline salts such as sodium or potassium salts of these polymers;
starches grafted by polyacrylates;
acrylamide/acrylic acid copolymers, typically in salt-form, in particular, alkaline salts such as sodium or potassium salts;
acrylamide/acrylic acid grafted starches, typically in salt-form, particularly alkaline salts, and in particular, sodium or potassium salts;
salts, particularly alkaline salts, and in particular, sodium or potassium salts of, carboxymethylcellulose;
salts, particularly alkaline salts, and in particular, sodium or potassium salts of, cross-linked polyaspartic acids;
salts, particularly alkaline salts, and in particular, sodium or potassium salts of, cross-linked polyglumatic acids and
their mixtures.

In particular, a compound chosen among the following can be used as an SAP in the composite material:
cross-linked sodium or potassium polyacrylates sold under the names SALSORB CL 10, SALSORB CL 20, FSA type 101, FSA type 102 (Allied Colloids); ARASORB S-310 (Arakawa Chemical); ASAP 2000, Aridall 1460 (Chemdal); KI-GEL 201-K (Siber Hegner); AQUALIC CA W3, AQUALIC CA W7, AQUALIC CA W10 (Nippon Shokuba); AQUA KEEP D 50, AQUA KEEP D 60, AQUA KEEP D 65, AQUA KEEP S 30, AQUA KEEP S 35, AQUA KEEP S 45, AQUA KEEP AI M1, AQUA KEEP AI M3, AQUA KEEP HP 200, NORSOCRYL S 35, NORSOCRYL FX 007 (Arkema); AQUA KEEP 10SH-NF, AQUA KEEP J-550 (Kobo); LUQUASORB CF, LUQUASORB MA 1110, LUQUASORB MR 1600, HYSORB C3746-5 (BASF); COVAGEL (Sensient technologies); SANWET IM-5000D (Hoechst Celanese);
starch-grafted polyacrylates sold under the names SANWET IM-100, SANWET IM-3900, SANWET IM-5000S (Hoechst);
starch-grafted acrylamide/acrylic acid copolymers in the form of sodium or potassium salt sold under the names WATERLOCK A-100, WATERLOCK A-200, WATERLOCK C-200, WATERLOCK D-200, WATERLOCK B-204 (Grain Processing Corporation);
acrylamide/acrylic acid copolymers in the form of sodium salt sold under the name WATERLOCK G-400 (Grain Processing Corporation);
carboxymethylcellulose sold under the name AQUASORB A250 (Aqualon);
cross-linked sodium polyglutamate sold under the name GELPROTEIN (Idemitsu Technofine).

It must be noted that superabsorbent polymers, in particular, superabsorbent polymers (polyelectrolytes) which contain alkaline ions such as sodium or potassium ions, for example, of the sodium or potassium poly(meth)acrylate type, are particularly adapted to using in a composite material according to the invention. Thus, in a specific embodiment, the superabsorbent polymer used in the framework of the present invention is a sodium or potassium poly(meth)acrylate, i.e. is chosen in the group consisting of a sodium polyacrylate, a potassium polyacrylate, a sodium polymethacrylate and a potassium polymethacrylate.

By “geopolymer” or “geopolymer matrix”, this means, in the framework of the present invention, a solid and porous material in a dry state, obtained following the hardening of a mixture containing finely ground materials (i.e. the alumino-silicate source) and a saline solution (i.e. the activation solution), said mixture being capable of setting and hardening over time. This mixture can also be described under the terms “geopolymeric mixture”, “geopolymer mixture”, “geopolymeric composition” or “geopolymer composition”. The hardening of the geopolymer is the result of the dissolution/polycondensation of the finely ground materials of the geopolymeric mixture in a saline solution such as a saline solution with a high pH level (i.e. the activation solution).

More specifically, a geopolymer or geopolymer matrix is an amorphous alumino-silicate inorganic polymer. Said polymer is obtained from a reactive material mainly containing silica and aluminium (i.e. the alumino-silicate source), activated by a highly alkaline solution, the solid/solution mass ratio in the formulation being low. The structure of a geopolymer is composed of a Si—O—Al network formed of silicate (SiO₄) and aluminate (AlO₄) tetrahedra connected at their apices by sharing oxygen atoms. Within this network, one or several charge-compensating cation(s), also called compensating cation(s) is/are located, which enable(s) to compensate for the negative charge of the AlO₄ complex. Said compensating cation(s) is/are advantageously chosen in the group consisting of alkaline metals such as lithium (Li), sodium (Na), potassium (K), rubidium (Rb) and caesium (Cs); alkaline earth metals such as magnesium (Mg), calcium (Ca), strontium (Sr) and barium (Ba); and their mixtures.

In a specific embodiment, when the superabsorbent polymer used in the framework of the present invention is a sodium poly(meth)acrylate, the compensating cation implemented will advantageously be sodium. As a variant, when the superabsorbent polymer used in the framework of the present invention is a potassium poly(meth)acrylate, the compensating cation implemented will advantageously be potassium.

The expressions “reactive material mainly containing silica and aluminium” and “alumino-silicate source” are, in the present invention, similar and can be used interchangeably.

The reactive material mainly containing silica and aluminium, which can be used for preparing the geopolymer matrix implemented in the framework of the invention is advantageously a solid source containing amorphous alumina-silicates. These amorphous alumina-silicates are, in particular, chosen among natural alumina-silicate minerals, such as illite, stilbite, kaolinite, pyrophyllite, andalusite, bentonite, kyanite, melanite, granite, amesite, cordierite, feldspar, allophane, etc.; calcined natural alumina-silicate minerals such as metakaolin; pure alumina-silicate-based synthetic glasses; aluminous cement; pumice; calcined sub-products or residue from industrial exploitation such as fly ash and blast furnace slag respectively obtained from coal combustion and during the transformation of iron ore into smelt in a blast furnace; and mixtures thereof.

The saline solution with a high pH level also known, in the field of geopolymerisation, as “activation solution”, is a highly alkaline aqueous solution which could possibly contain silicate components particularly chosen in the group consisting of silica, colloidal silica and vitreous silica.

The expressions “activation solution”, “saline solution with a high pH” are, in the present invention, similar and can be used interchangeably.

By “highly alkaline” or “high pH”, this means a solution of which the pH is higher than 9, particularly higher than 10, in particular, higher than 11, and more specifically, higher than 12. In other words, the activation solution has an OH-concentration higher than 0.01 M, particularly higher than 0.1 M, in particular, higher than 1 M and, more specifically, between 5 and 20 M.

The activation solution includes the compensating cation or the mixture of compensating cations in the form of an ionic solution or a salt. Thus, the activation solution is, in particular, chosen among an aqueous solution of a sodium silicate (Na₂SiO₃), potassium silicate (K₂SiO₂), sodium hydroxide (NaOH), potassium hydroxide (KOH), calcium hydroxide (Ca(OH)₂), caesium hydroxide (CsOH) and their derivatives, etc.

In the material that is the subject of the present invention, the superabsorbent polymer(s) is/are incorporated in the geopolymer matrix up to an incorporation rate of 10% by mass in relation to the total mass of said material. Advantageously, this incorporation rate is between 0.1 and 5% and, in particular, between 0.2 and 3% by mass in relation to the total mass of said material.

The material that is the subject of the present invention can be presented in various forms, small or large in size, according to the desired application and, in particular, structures of a predetermined form in the framework of 3D printing. Thus, the material that is the subject of the present invention can be in the form of a fine powder, a coarse powder, grains, granules, pastilles, beads, balls, blocks, rods, cylinders, plates, structures or mixtures thereof. These various forms can be obtained, in particular, thanks to the plasticity, before hardening, of the geopolymer matrix of the material that is the subject of the present invention.

The present invention relates to a formulation, or kit, for preparing a composite material such as previously defined, including:
an alumino-silicate source, in particular, such as previously defined;
an activation solution, in particular, such as previously defined and
at least one superabsorbent polymer, in particular, such as previously defined.

The present invention also relates to a method for preparing a composite material such as previously defined. Said preparation method includes a step consisting of incorporating at least one superabsorbent polymer in a geopolymer mixture.

In other words, the preparation method according to the invention consists of mixing together all the different elements of the formulation, such as previously defined.

In a 1^{st} form of implementation, the preparation method according to the present invention includes the following steps:

a) preparing an activation solution including at least one superabsorbent polymer,

b) adding at least one alumino-silicate source to the solution obtained in step (a),

c) subjecting the mixture obtained in step (b) to conditions enabling the hardening of the geopolymer.

Step (a) of the method according to the present invention consists of adding at least one superabsorbent polymer to an activation solution, such as previously defined, previously prepared. The prior preparation of the activation solution is a conventional step in the field of geopolymers.

As previously explained, the activation solution can possibly contain one or several silicate component(s), in particular chosen in the group consisting of silica, colloidal silica and vitreous silica. When the activation solution contains one or several silicate component(s), the latter is/are present in a quantity of between 100 mM and 10 M, particularly between 500 mM and 8 M and, in particular, between 1 and 6 M in the activation solution.

The superabsorbent polymer(s) is/are added to the activation solution at one go or in batches. Once the superabsorbent polymer(s) is/are added to the activation solution, the solution or dispersion obtained is mixed by using a mixer, a stirrer, a bar magnet, an ultrasound bath or a homogeniser. The mixing/blending during the sub-step (a) of the method according to the invention is carried out at a relatively slow speed. By “relatively slow speed”, this means, in the framework of the present invention, a rotating speed of the mixer rotor of less than or equal to 25 rpm, particularly less than or equal to 20 rpm and, in particular, more than or equal to 20 rpm. Advantageously, this stirring is carried out using a bar magnet. This stirring is quickly stopped because of the gelling of the activation solution. Thus, following step (a) of the method according to the invention, an activation solution including at least one superabsorbent polymer is obtained, presented in the form of a gelled solution wherein the superabsorbent polymer nodules are evenly distributed or dispersed.

Step (a) of the method according to the invention is carried out at a temperature of between 10° C. and 40° C., advantageously between 15° C. and 30° C. and, more specifically, at room temperature (i.e. 23° C.±5° C.) for a duration of less than 30 minutes, particularly less than 15 minutes, in particular, between 15 seconds and 10 minutes and, more specifically, between 30 seconds and 5 minutes.

Step (b) of the method according to the invention consists of putting in contact the activation solution including at least one superabsorbent polymer and the alumino-silicate source such as previously defined.

The alumino-silicate source can be poured at one go or in batches on the activation solution containing at least one superabsorbent polymer. In a specific form of implementation in step (b), the alumino-silicate source can be sprinkled on the activation solution containing at least one superabsorbent polymer.

Advantageously, step (b) of the method according to the invention is implemented in a mixer wherein the activation solution containing at least one superabsorbent polymer has been previously introduced. Any mixer known to a person skilled in the art can be used in the framework of the present invention. As non-exhaustive examples, a NAUTA® mixer, a HOBART® kneader and a HENSCHEL® kneader can be cited.

Step (b) of the method according to the invention therefore includes a mixture or blend of the activation solution including at least one superabsorbent polymer with the alumino-silicate source. The mixing/blending during step (b) of the method according to the invention is done at a relatively sustained speed. By “relatively sustained speed”, this means, in the framework of the present invention, a speed higher than 25 rpm, in particular higher than or equal to 35 rpm.

Step (b) of the method according to the invention is carried out at a temperature of between 10° C. and 40° C., advantageously between 15° C. and 30° C. and, more specifically, at room temperature (i.e. 23° C.±5° C.) for a duration of more than 1 minute, particularly between 2 minutes and 30 minutes and, in particular, between 4 minutes and 15 minutes.

A person skilled in the art will be able to determine the quantity of alumino-silicate source to be used in the framework of the present invention according to their knowledge in the field of geopolymerisation, as well as the type of superabsorbent polymer(s) implemented and the quantity of superabsorbent polymer(s) and activation solution implemented.

Advantageously, in the method according to the present invention, the activation solution/MK mass ratio with activation solution representing the activation solution mass containing one or several superabsorbent polymer(s) (expressed in g) and MK representing the alumino-silicate source mass (expressed in g) used is advantageously between 0.6 and 2, and in particular, between 1 and 1.5. As a specific example, the activation solution/MK ratio is around 1.3 (i.e. 1.3±0.1).

In addition, further to the alumino-silicate source, sand, granulate and/or fines can be added to the activation solution during step (b) of the method according to the invention.

By “granulate”, this means a granular material, natural, artificial or recycled, of which the average grain size is advantageously between 10 and 125 mm.

Fines, also called “fillers” or “added fines” is a dry product, finely split, from the sizing, sawing or working of natural rocks, of granulates, such as previously defined and ornamental stones. Advantageously, fines have an average grain size, in particular, of between 5 and 200 μm.

Sand, granulate and/or fines is/are added to best regulate the temperature rise during step (b) of the method, but also to optimise the physical and mechanical properties of the composite material obtained.

The sand possibly added during step (b) can be a limestone sand or a silica sand. Advantageously, it is a silica sand which enables to achieve the best results concerning the optimisation of the physical and mechanical properties of the composite material obtained. By “silica sand”, this means, in the framework of the present invention, a sand constituted of more than 90%, particularly more than 95%, in particular more than 98% and, more specifically, more than 99% silica (SiO₂). The silica sand implemented in the present invention advantageously has an average grain size, particularly less than 10 mm, particularly less than 7 mm and, in particular, less than 4 mm. As a specific example, a silica sand that has an average grain size of between 0.2 and 2 mm can be used.

When sand is added in addition to the alumino-silicate source to the activation solution, the mass ratio between sand and aluminosilicated source is between 2/1 and 1/2, particularly between 1.5/1 and 1/1.5, in particular, between 1.2/1 and 1/1.2.

Step (c) of the method according to the invention consists of subjecting the mixture obtained in step (b) to conditions enabling the hardening of the geopolymer mixture.

Any technique known to a person skilled in the art to make a geopolymer mixture harden wherein superabsorbent polymer(s) is/are present, can be used during the hardening step of the method.

The conditions enabling hardening during step (c) advantageously include a curing step, possibly followed by a drying step. The curing step can be carried out in the fresh air, under water, in various airtight moulds, by humidifying the atmosphere surrounding the geopolymer mixture or by applying waterproofing on said mixture. This curing step can be implemented at a temperature of between 10 and 80° C., particularly between 20 and 60° C. and, in particular, between 30 and 40° C. and can last between 1 and 40 days, even longer. It is clear that the curing duration depends on the conditions implemented during the latter, and a person skilled in the art will be able to determine the most suitable duration, once the conditions are defined and possibly by routine testing.

When the hardening step includes a drying step, in addition to the curing step, this drying can be done at a temperature of between 30 and 90° C., particularly between 40 and 80° C. and, in particular, between 50 and 70° C. and can last between 6 hours and 10 days, particularly between 12 hours and 5 days and, in particular, between 24 and 60 hours.

In addition, prior to the hardening of the geopolymer mixture wherein at least one superabsorbent polymer is present, the latter can be placed in moulds or in containers, so as to give it a predetermined form following or prior to this hardening.

Likewise, the geopolymer mixture wherein at least one superabsorbent polymer is present is absolutely suitable, prior to the hardening thereof, for an injection through 3D printer nozzles, as well as for maintaining and holding the printed shape.

In a 2^{nd} form of implementation, the method according to the present invention includes the following steps:

a′) adding at least one alumino-silicate source to an activation solution,

b′) adding said at least one superabsorbent polymer to the mixture obtained in step (a′),

c′) subjecting the mixture obtained in step (b′) to conditions enabling the hardening of the geopolymer.

Step (a′) of the method according to the present invention consists of preparing an activation solution, such as previously defined wherein at least one alumino-silicate source, such as previously defined is added. Such a sub-step is conventional in the field of geopolymers.

Everything that has been previously defined regarding the activation solution during step (a) is also applied to the activation solution implemented during step (a′).

Likewise, everything which has previously been defined for step (b) and, in particular, the mixing/blending conditions, the type of mixer, the temperature, the quantity of alumino-silicate source and the activation solution/MK ratio is applied, mutatis mutandis, in step (a′). However, it must be noted, that the stirring during step (a′) can have a duration of more than 2 minutes, particularly between 4 minutes and 1 hour and, in particular, between 5 minutes and 30 minutes.

Step (b′) of the method consists of inserting, in the mixture (activation solution+alumino-silicate source), at least one superabsorbent polymer. It is clear that this step must be implemented relatively quickly after preparing the aforementioned mixture and this, prior to any hardening of this mixture which could prevent obtaining a homogenous mixture following step (b′).

The superabsorbent polymer(s) is/are added to the mixture (activation solution+alumino-silicate source) at one go or in batches. Once the superabsorbent polymer(s) is/are added to the mixture (activation solution+alumino-silicate source), the preparation obtained is mixed by using a mixer, a stirrer, a bar magnet, an ultrasound bath or a homogeniser. The mixing/blending during step (b′) of the method according to the invention is done at a relatively sustained speed, such as previously defined and this, to obtain a homogenous mixture following step (b′).

Step (b′) of the method according to the invention is carried out at a temperature of between 10° C. and 40° C., advantageously between 15° C. and 30° C. and, more specifically, at room temperature (i.e. 23° C.±5° C.) for a duration of less than 30 minutes, particularly less than 15 minutes, in particular between 15 seconds and 10 minutes and, more specifically, between 30 seconds and 5 minutes.

In addition, as considered in the framework of the 1^{st} form of implementation, sand, a granulate and/or fines, such as previously defined, can be used for preparing the composite material that is the subject of the invention. Sand, granulate and/or fines can be added during step (a′); following step (a′) and prior to step (b′); during step (b′) and/or following step (b′) and prior to step (c′).

Finally, everything that has been defined for step (c) also applies to step (c′).

The present invention also relates to using a composite material such as previously defined or likely to be prepared by a preparation method, such as previously defined as a material for 3D printing.

In addition, as previously explained and illustrated in the experimental part below, the properties provided to a geopolymer, following the addition of one or several superabsorbent polymer(s), enable to consider other uses for the composite material according to the invention and, in particular, in the field of construction. Thus, the present invention relates to using a composite material, such as previously defined, or likely to be prepared by a preparation method, such as previously defined:

(i) as a sealer,

(ii) as a seal, given the improved adhesion properties by adding one or several superabsorbent polymer(s) and/or

(iii) as sprayed concrete.

The present invention also relates to a method for preparing a microporous and mesoporous geopolymer including steps consisting of:

1) preparing a composite material including at least one superabsorbent polymer in a geopolymer matrix according to the preparation method, such as previously defined, then

2) removing said at least one superabsorbent polymer through a treatment chosen in the group consisting of a heat treatment, an oxidative treatment, a photodegradation treatment and an extraction via a supercritical fluid or ultrasound.

Step (2) of the method according to the present invention consists of removing the superabsorbent polymer(s) and thus releasing the porosity of the composite material obtained following step (1). Different variants are considered regarding this removal.

The 1^{st} of these variants consists of a heat treatment. By “heat treatment” this means, in the framework of the present invention, the fact of subjecting the composite material in step (1) to a high temperature, i.e. a temperature higher than 200° C., particularly between 300° C. and 1000° C. and, in particular, between 400° C. and 800° C.

This heat treatment is advantageously carried out under oxygen, under air, under an inert gas such as argon or under a neutral gas such as nitrogen, and advantageously, under oxygen or under air. This heat treatment step consists of a calcination or a sublimation of the organic compounds, which are the superabsorbent polymers implemented.

This step has a duration of between 15 minutes and 12 hours and, in particular, between 1 hour and 6 hours. It is possible for a person skilled in the art to make the heat treatment conditions vary and this, according to the composite material obtained at the end of step (1) in view of obtaining a porous geopolymer, free of any organic compound.

The 2^{rd} of the variants considered for removing the superabsorbent polymer(s) used, consists of oxidising these elements mainly into CO₂ and H₂O. Such an oxidising treatment is, in particular, either a plasma treatment, or an ozone treatment.

The plasma treatment consists of exposing the composite material obtained following step (1) to a plasma. As a reminder, plasma is a gas in an ionised state, conventionally considered as a fourth state of matter. The energy necessary for ionising a gas is provided by means of an electromagnetic wave (radiofrequency or microwave). Plasma is composed of neutral molecules, ions, electrons, radical species (chemically very active) and excited species which will react with the surface of the materials.

Plasmas known as “cold” and plasmas known as “hot” are distinguished from each other, as regards the ionisation rate of the species contained in the plasma. For plasmas known as “cold”, the ionisation rate of the reactive species is less than 10⁻⁴ whereas for plasmas known as “hot”, it is more than 10⁻⁴. The terms “hot” and “cold” come from the fact that plasma known as “hot” contains a lot more energy than plasma known as “cold”.

Plasma is advantageously generated by a mixture of at least two gases, the first and the second gas respectively being chosen in the group consisting of inert gases and the group consisting of air and oxygen. The duration of the plasma treatment is between 1 and 30 minutes, and in particular, between 5 and 15 minutes.

An ozone treatment consists of exposing the composite material obtained following step (1) to ozone. This exposure can involve either the putting into contact of this composite material with an ozone flow or placing the latter in an atmosphere containing ozone.

The necessary ozone can be obtained, from a gas rich in oxygen such as air, oxygen, air enriched in oxygen or a gas enriched in oxygen, via an ozone generator such as an UVO-Cleaner Model 42-200 with a low-pressure mercury vapour lamp (28 mW/cm², 254 nm). The duration of the ozone treatment can vary. As non-exhaustive examples, this duration is advantageous between 30 seconds and 3 hours, particularly between 1 minute and 1 hour, in particular, between 5 minutes and 30 minutes and, more specifically, around 10 minutes (10 minutes±3 minutes).

The 3^{rd} of the variants considered for removing the superabsorbent polymer(s) used is a photodegradation treatment. The latter consists of a degradation of the organic compounds contained in the composite material obtained following step (1) by means of an exposure of a light beam and, in particular, a UV light.

Advantageously, the UV light implemented has a wavelength of between 10 nm and 400 nm, particularly between 100 nm and 380 nm and, in particular, between 180 nm and 360 nm. Any UV source can be used to generate such a UV light. As an example, a UV lamp, a low-pressure mercury lamp, a medium-pressure mercury lamp, a high-pressure mercury lamp, a very-high-pressure mercury lamp, an electric arc lamp, a halide lamp, a xenon lamp, a laser, an ArF excimer lamp, a KrF excimer lamp, an excimer lamp or synchrotron radiation can be cited.

UV treatment, in the framework of the present invention, can be carried out at a temperature of between 5° C. and 120° C., particularly between 10° C. and 80° C. and, in particular, between 15° C. and 40° C. More specifically, UV treatment according to the invention is carried out at room temperature. UV treatment, in the framework of the present invention, last from 1 minute to 5 hours, particularly from 5 minutes to 1 hour and, in particular, from 10 minutes to 45 minutes. The irradiation can be unique or be repeated several times, particular from 2 to 20 times and in particular, from 3 to 10 times.

This UV treatment is advantageously carried out under gas and, in particular, in the presence of a gas rich in oxygen and/or in ozone, such as air, oxygen, air enriched in oxygen and/or in ozone or a gas enriched in oxygen and/or in ozone.

The last of these variants consists of an extraction of the organic compounds which are the superabsorbent polymers implemented by a supercritical fluid or ultrasound.

In view of the above and the below, the expression “supercritical fluid” is used in the usual acceptance thereof, namely that a “supercritical fluid” is a fluid heated at a temperature higher than the critical temperature thereof (maximum temperature in the liquid phase, whatever the pressure or temperature of the critical point) and subjected to a pressure higher than the critical pressure thereof (critical point pressure), the physical properties of such a supercritical fluid (density, viscosity, diffusivity) being intermediate between those of liquids and those of gases. Step (2) of the method according to the invention builds on the remarkable solubility properties of the organic compounds which supercritical fluids have.

Any supercritical fluid known to a person skilled in the art and generally used in methods for extracting or solubilising organic materials can be used in the framework of the present invention. Advantageously, the supercritical fluid used in the framework of step (2) of the method according to the present invention is chosen in the group consisting of supercritical carbon dioxide (CO₂), supercritical nitric oxide (N₂O), supercritical Freon-22, supercritical Freon-23, supercritical methanol, supercritical hexane and supercritical water. More specifically, the supercritical fluid used in the framework of step (2) of the method according to the present invention is supercritical CO₂, the critical temperature thereof (31° C.) and the critical pressure thereof (74 Bars) being relatively easy to reach.

Ultrasound treatment can be carried out on the composite material obtained following step (1) placed with an adapted solvent in an ultrasound beaker or with an ultrasound probe and this, for a duration of between 5 minutes and 24 hours, and in particular, between 10 minutes and 12 hours. As examples, an ultrasound beaker or an ultrasound probe releasing a power of between 200 W and 750 W and functioning at a frequency of between 10 and 45 kHz can be used.

This extraction step that is carried out both with a supercritical fluid and with ultrasound, has a duration of between 15 minutes and 12 hours and, in particular, between 1 hour and 6 hours. It is possible for a person skilled in the art to make the treatment via a supercritical fluid vary, and this, according to the composite material obtained at the end of step (1), in view of obtaining a porous geopolymer, free of any organic compound.

Once step (2) of the method according to the invention is implemented, a mesoporous and microporous geopolymer, i.e. geopolymer that has both macropores and mesopores, is obtained. By “macropores”, this means pores or voids that have an average diameter of more than 50 nm, and in particular, more than 70 nm. By “mesopores”, this means pores or voids that have an average diameter of between 2 and 50 nm and, in particular, between 2 and 20 nm. In this geopolymer, macropores, in the main, come from nanonodules and/or micronodules of superabsorbent polymers, whereas mesopores mainly result from the geopolymerisation method. Thus, the geopolymer obtained following the method according to the present invention has an open porosity, a penetrating open porosity, a connected porosity and a closed porosity.

It is useful to note that modulating the quantity of superabsorbent polymers implemented during step (1), i.e. during the preparation of the composite material, enables to impact the size of the superabsorbent polymer nodules and, hence, the final porosity in the geopolymer obtained following step (2). The final porosity in the geopolymer can therefore be predetermined from step (1) of the method according to the present invention.

Other characteristics and advantages of the present invention will again appear to a person skilled in the art, upon reading the examples below, given as an illustration and non-exhaustively, in reference to the appended figures.

### BRIEF DESCRIPTION OF THE DRAWINGS

FIGS. 1A to 1E are photographs taken under an optical microscope of sodium polyacrylate (Aquakeep) in different environments: in the dry state (FIG. 1A), 0.2% by mass of Aquakeep in water (FIG. 1B), 0.2% by mass of Aquakeep in an activation solution (FIG. 1C), 0.5% by mass of Aquakeep in an activation solution (FIG. 1D) and 1% by mass of Aquakeep in an activation solution (FIG. 1E).

FIG. 2 presents the impact of the Aquakeep concentration on the rheology of the activation solution.

FIGS. 3A and 3B respectively present the impact of the Aquakeep concentration on the elasticity and on the setting time. In FIG. 3A, “G′ref” corresponds to the measurement carried on a reference geopolymer without Aquakeep and “G′0.2%”, “G′0.5%” and “G′1%” respectively correspond to the measurements on the geopolymers including 0.2%, 0.5% and 1% by mass of Aquakeep. In FIG. 3B, “tan d ref” corresponds to the measurement carried out on a reference geopolymer without Aquakeep and “tan d 0.2%”, “tan d 0.5%” and “tan d 1%” respectively correspond to the measurements on the geopolymers including 0.2%, 0.5% and 1% by mass of Aquakeep.

FIGS. 4A and 4B respectively present the impact of the geopolymerisation time (30 minutes “t30”, 1 hour 30 minutes “t1h30”, 1 hour 50 minutes “t1h50” and 2 hours 30 minutes “t2h30”) on the stress according to the shearing rate and on the viscosity according to the shearing rate, the caption 0.5% SA corresponding to one single activation solution containing 0.5% of sodium polyacrylate.

### DETAILED DESCRIPTION OF SPECIFIC EMBODIMENTS

I. Materials Used and Choice of Formulation.

In all the examples below, the alumino-silicate source used is metakaolin. The metakaolin used is Pieri Premix MK (Grace Construction Products), of which the composition determined by fluorescence X is recorded in Table 1. The specific surface area of this material, measured by the Brunauer-Emmet-Teller method, is equal to 19.9 m²/g and the average diameter of the particles (d₅₀), determined by laser granulometry, is equal to 5.9 μm.

TABLE 1
Chemical composition of the metakaolin used.

| | Mass % | | | | | | | | |
|---|---|---|---|---|---|---|---|---|---|
| | SiO₂ | Al₂O₃ | CaO₃ | Fe₂O₃ | TiO₂ | K₂O | Na₂O | MgO | P₂O₅ |
| Metakaolin | 54.40 | 38.40 | 0.10 | 1.27 | 1.60 | 0.62 | <0.20 | <0.20 | / |

In all the examples below, the compensating cations and mineralisation agents retained are alkaline hydroxides, inserted in the form of NaOH granules (Prolabo, Rectapur, 98%).

A sodium silicate like Betol 39T (Woellner) is also implemented in all the examples below.

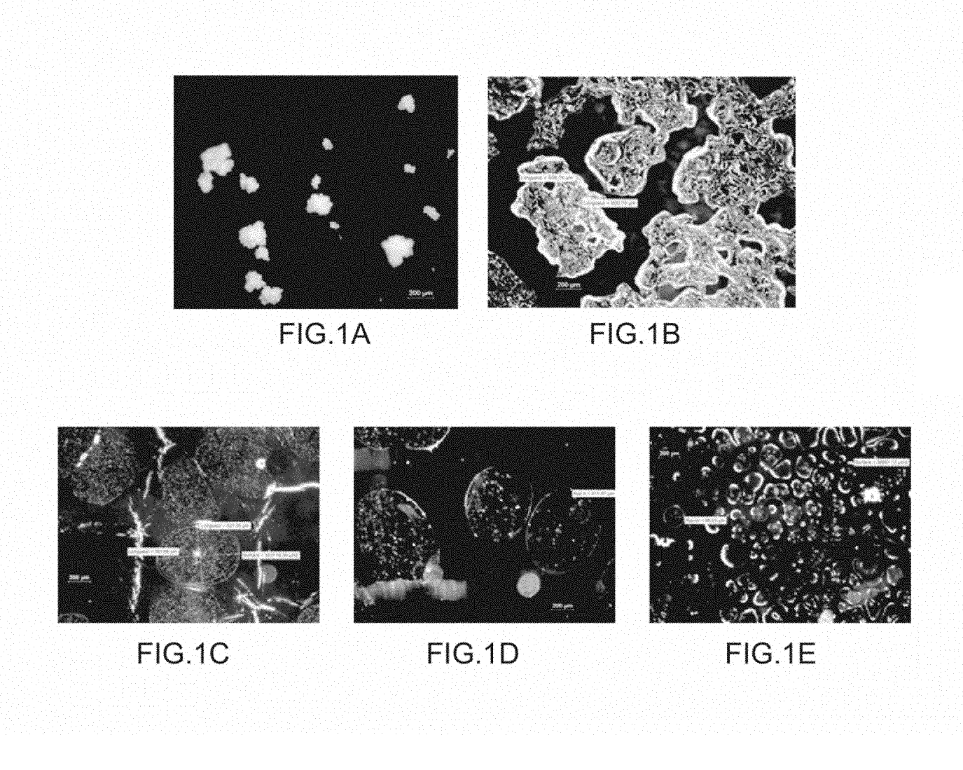

Finally, the superabsorbent polymer implemented in all the examples below is a sodium polyacrylate (PaaNa) commercialised under the brand Aquakeep 10SH-NF (SUMIMOTO SEIKA). FIG. 1 presents a series of photographs of the Aquakeep taken under optical microscope in different environments. In the dry state, the latter is presented in the form of agglomerates of spherical beads, of which the average diameter is 25 μm (data from the supplier) (FIG. 1A). During the addition of 0.2% of Aquakeep in the water, it swells by absorbing water (FIG. 1B). FIGS. 1C, 1D and 1E present the impact of the Aquakeep content in a geopolymer activation solution (basic alkaline silicate solution). The more the Aquakeep concentration is high, the more the size of the nodules decreases, certainly because of an absorption of a weaker solution, but also because of a depolymerisation of the cross-linked network.

The geopolymer formulation that conforms with the present invention, used in the examples, is given in Table 2 below:

TABLE 2
Geopolymer formulation used.

| | Composition: mass (g) | Quantity of Aquakeep (g) |
|---|---|---|
| Geo-SAP | Metakaolin = 60.02 | 0.279 -> 0.2% by mass |
| | NaOH = 11.8 | 0.699 -> 0.5% by mass |
| | Alkaline silicate = 58.61 | 1.397 -> 1% by mass |
| | Water = 9.32 | |

II. Preparation and Characterisation of the Geopolymer that Conforms with the Present Invention.

II.1. Preparation of the Activation Solution Containing Aquakeep.

The alkaline silicate solution is prepared at room temperature, then Aquakeep is added to this activation solution using a magnetic stirrer. This solution gels by swelling the cross-linked polymers, due to the absorption of a certain quantity of saline solution, the degree of gelling increasing with the Aquakeep concentration.

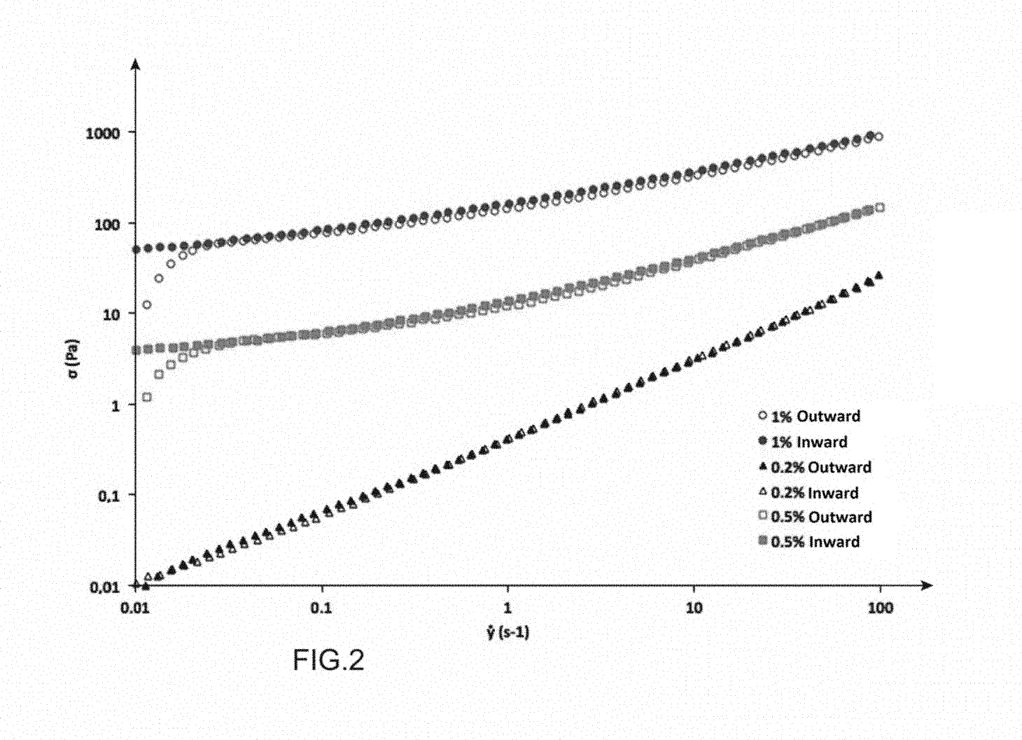

The activation solutions containing Aquakeep have been characterised rheologically (FIG. 2) and it is observed that for a 0.2% Aquakeep concentration, the solution behaves like a Newtonian fluid, whereas for a 0.5% or 1% Aquakeep concentration, a gelled solution appears (G′>G″) with a flow threshold.

For a 0.5% Aquakeep concentration, the threshold is around equal to 4 Pa and, for a 1% Aquakeep concentration, the threshold is equal to around 45 Pa. These flow curves can be perfectly defined by a Herschel-Bulkley-type law.

II.2. Addition of Metakaolin and Characterisation of the Reopolymer Obtained.

When the initial solution (activation solution+Aquakeep) is ready, the metakaolin is added to it, at room temperature, by relatively sustained stirring for a duration of around 10 minutes and the geopolymerisation reactions take place. The geopolymer is formed around SAP grains and the material obtained is left to harden.

Elastic Module and Setting Time

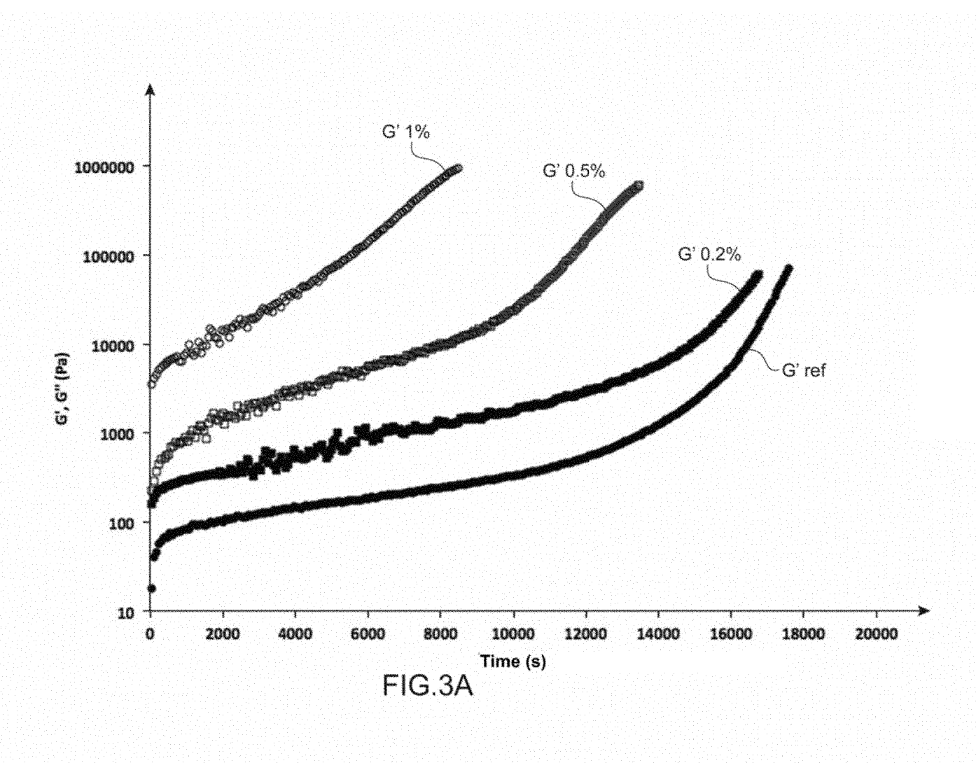

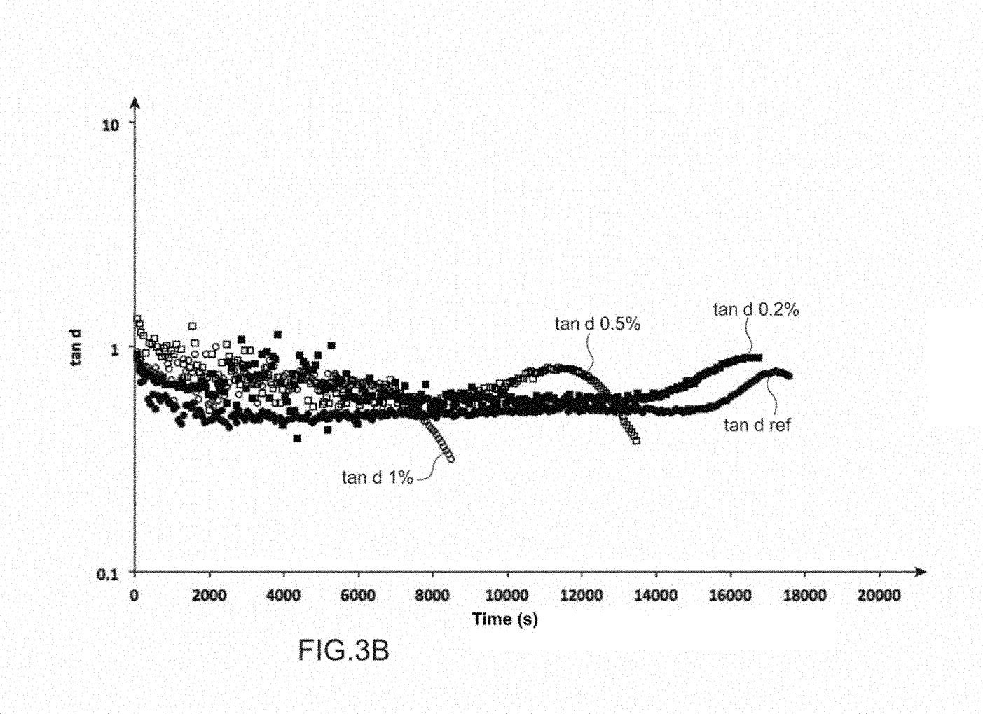

FIG. 3A presents the development of the elastic module (G′) over time and according to the Aquakeep content. When the concentration increases, the elasticity increases because of the interactions between the PaaNa nodules and the setting time decreases (maximum on Tan delta in FIG. 3B), since sodium is added in the solution, and therefore the Si/Na ratio decreases. The elasticity increases by more than two decades, only with an addition of 1% by Aquakeep mass.

Rheological Flow Behaviour

The rheological flow behaviour has also been determined in order to obtain the development of the flow threshold and the viscosity with the shearing rate.

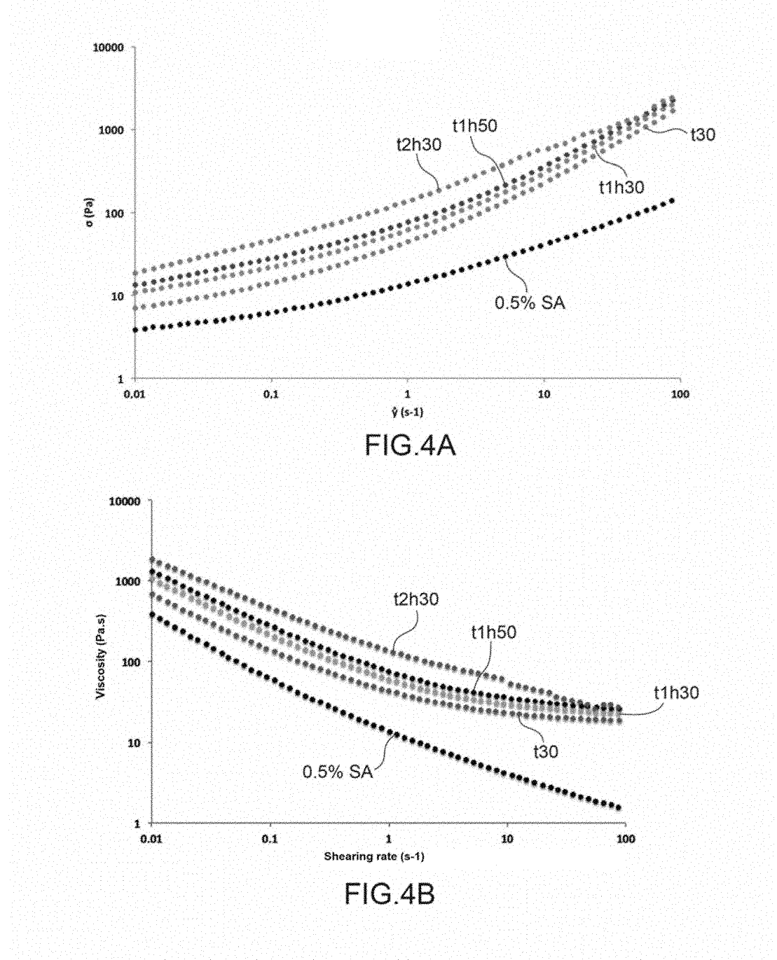

FIG. 4A enables to determine the flow threshold (plateau which is drawn at a low shearing rate). It thus goes from 4 Pa for the activation solution to around 15-20 Pa at the end of 2 hours 30 minutes of geopolymerisation. It must be noted that the rheological behaviour differs a little from that of the activation solution.

It would appear that the relaxation time, characteristic of the geopolymer paste with Aquakeep is longer, and that consequently, the stress plateau appears at a low shearing rate. This characteristic is truly found in the development of viscosity where a Newtonian plateau is drawn at a high shearing rate (FIG. 4B). Another useful characteristic is the shear-thinning characteristic (decrease of viscosity with the shearing rate) of the mixture which is beneficial for injection methods.

Adhesion Properties

Concerning the increase of adhesion properties, observation at laboratory-level enable this increase to be observed.

Indeed, the act of adding sodium polyacrylate (PaaNa) enables a better affinity with plastic pots wherein the mixtures are produced.

### REFERENCES

[1] J. L. Provis, J. S. J Van Deventer, Woodhead, Cambridge, UK; 2009
[2] P. Steins, A. Poulesquen, F. Frizon, O. Diat, J. Jestin, J. Causse, D. Lambertin, S. Rossignol, Journal of Applied Crystallography, 47, (2014), 316-324
[3] Q. Li, Z. Sun, D. Tao, Y. Xu, P. Li, H. Cui, J. Zhai, Journal of hazardous materials, 262 (2013), 325-331
[4] A. Fernandez-Jimenez, A. Palomo, D. E. Macphee, E. E. Lachowski, J. Am. Ceram. Soc, 88(5), 2005, 1122-1126
[5] R. Castellani, A. Poulesquen, F. Goettmann, P. MArchal, L. Choplin, Col and Surf A, 454, (2014), 89-95
[6] A. Assmann, Dissertation of Stuttgart University, 2013: http://elib.uni-stuttgart.de/opus/volltexte/2013/8441/pdf/Dissertation_Alexander_Assmann.pdf
[7] http://www.rilem.org/docs/2013142837_225-sap-unedited-version.pdf

What is claimed is:

1- Use of a composite material including at least one superabsorbent polymer in a geopolymer matrix as a material for 3D printing.

2- Use according to claim 1, characterised in that said superabsorbent polymer is chosen in the group constituted by:
polymers resulting from polymerisation with partial cross-linking of water-soluble ethylenic unsaturated monomers, such as acrylic, methacrylic or vinylic monomers, in particular, cross-linked and neutralised poly(meth)acrylates; and salts, in particular, alkaline salts such as sodium or potassium salts of these polymers;
starches grafted by polyacrylates;
acrylamide/acrylic acid copolymers, typically in salt-form, in particular, alkaline salts such as sodium or potassium salts;
acrylamide/acrylic acid grafted starches, typically in salt-form, particularly alkaline salts, and in particular, sodium or potassium salts;
salts, particularly alkaline salts, and in particular, sodium or potassium salts of, carboxymethylcellulose;
salts, particularly alkaline salts, and in particular, sodium or potassium salts of, cross-linked polyaspartic acids;
salts, particularly alkaline salts, and in particular, sodium or potassium salts of, cross-linked polyglumatic acids and
their mixtures.

3- Use according to claim 1, characterised in that said superabsorbent polymer is a sodium or potassium poly(meth)acrylate.

4- Use according to any one of the claim 1, characterised in that said composite material is prepared from a formulation including:
an alumino-silicate source;
an activation solution and
at least one superabsorbent polymer.

5- Use according to any one of the claim 1, characterised in that said composite material is prepared by a preparation method consisting of mixing together the different formulation elements, such as defined in claim 4.

6- Use according to any one of the claim 1, characterised in that said composite material is prepared by a preparation method consisting of:
a) preparing an activation solution including at least one superabsorbent polymer,
b) adding at least one alumino-silicate source to the solution obtained in step (a),
c) subjecting the mixture obtained in step (b) to conditions enabling the hardening of the geopolymer.

7- Use according to any one of the claim 1, characterised in that said composite material is prepared by a preparation method consisting of:
a′) adding at least one alumino-silicate source to an activation solution,
b′) adding at least one superabsorbent polymer to the mixture obtained in step (a′),
c′) subjecting the mixture obtained in step (b′) to conditions enabling the hardening of the geopolymer.
